(19) United States
(12) Patent Application Publication
(10) Pub. No.: US 2012/0319812 A1
(43) Pub. Date: Dec. 20, 2012

(54) Assembling magnetic component

(76) Inventor: S. R. SHANG, Ta Wu Lung Keelung (TW)

(21) Appl. No.: 13/164,367

(22) Filed: Jun. 20, 2011

(51) Int. Cl. H01F 27/24

(52) U.S. Cl. 336/233

(57) ABSTRACT

The main purpose of this invention is to improve high forming pressure of existing Fe—Si—Al insulating magnetic powder which is not suitable for forming, combine heterogeneous insulating magnetic powder, produce hollow cup-like cover and Fe—Si—Al rod core for full magnetic path component assembling, and change the shape structure of rod core and cover design, so there will be advantages including easy to winding, assemble and cooling.

### BACKGROUND OF THE INVENTION

1. Technical Field

This invention mainly assembles the rod core and cover assembling structure produced by heterogeneous insulating magnetic powder, in order to meet the advantage characteristics, including easy coiling, assembling and heating dissipation.

2. Description of Related Art

The large current assembling magnetic component used in market condition is mainly separated into the following two types:
Type 1: As for rod core and cover integral magnetic component, top and bottom covers of iron insulating magnetic powder are used to assemble the finished product. As demonstrated in FIG. 26, the rod core is built in top and bottom covers, so there is no separated rod core.
Type 2: Concerning the magnetic component of separated rod core and cover, cover of iron or Fe—Si insulating magnetic powder is used to be assembled with rod core of iron or Fe—Si insulating magnetic powder, which is demonstrated in FIG. 27.

However, there are several obvious disadvantages in the above two traditional magnetic components, which is demonstrated in the comparative table in Brief summary of the invention.

### BRIEF SUMMARY OF THE INVENTION

Before describing the technology content of this invention, please allow us to define or explain the material or technology applied in this invention as follow:
Rod core: The magnetic inductive material surrounded by coil in general magnetic component, which can be single individual or with components according to requirements, and there are different shape variations, such as T type and rod type.
Magnetic powder: Iron powder or alloy powder with magnetic characteristic. Resin obtained from market condition is used to perform surface insulation coating, to form magnetic powder with insulation characteristic on the surface. After that, it will form through pressing by cold-forming technology.
Coil: Coil mentioned in this invention is copper wire with insulation surface which coils and becomes coils in single or multiple turns, in order to carry current and generate external magnetic field.
Assembly: Assembly mentioned in this invention is to reserve holes, tenon, and location design for assembly of each component previously, and combine by mechanical or manual means. Common glue sold in market condition can be used for adhesion between each component, such as epoxy resin, silica gel, and instant glue.
Cold forming technology: Press the powder to form. Mechanical pressure is mainly used to form, and then the product is completed by annealing and sintering.

The following is the advantage and disadvantage comparison of existing Type 1, Type 2 products and this invention, for understanding of characteristics and differences:

| | The aim of this | Traditional | Traditional |
|---|---|---|---|
| Comparison | invention | type 1 | type 2 |
| Difference | Top cover, | Top cover and | Single cover |
| explanation | bottom cover | bottom cover are | and rod core |
| | and rod core | formed, which | are formed, |
| | are separated, | will be assembled | which will be |
| | which will be | with coil to form | assembled with |
| | assembled with | finished product | coil to form |
| | coil to form | afterwards, rod | finished product |
| | finished product | core is built in | afterwards. |
| | afterwards. | top and bottom | |
| | | covers, so there | |
| | | is no rod core. | |
| Multiple | Yes. | No; rod core is built | Yes. |
| material | | in top and bottom | |
| combination | | covers, so rod core | |
| | | requires top and | |
| | | bottom cover | |
| | | materials. | |
| Using | Yes; high-length | No; it can't be | Yes; but only for |
| high- | Fe—Al—Si rod | formed because of | short-length |
| length | core can be | high forming | Fe—Al—Si rod |
| Fe—Al—Si | produced by | pressure. | core. |
| rod core | using the | | |
| | prescription of | | |
| | this invention. | | |
| Forming | Lowest; each | High. | Medium. |
| pressure | component is | | |
| for unit | formed | | |
| area | separately, so the | | |
| | forming pressure | | |
| | is the lowest. | | |
| Using coil | Yes. | Yes. | No; because of |
| with large | | | cover space |
| diameter | | | limitation, large |
| wire | | | diameter wire |
| (>1.7 mm) | | | can't be used. |
| Application | Yes. | No | No |
| of high | | recommended; | recommended; |
| current and | | because when using | because coil with |
| high | | iron powder as the | large diameter |
| inductor | | material, the core | wire can't be |
| | | loss is too high, | used, it is not |
| | | which is not | suitable for the |
| | | suitable for the | application of |
| | | application of high | high current and |
| | | current and high | high inductor. |
| | | inductor. | |
| Variability | Yes; because of | No. | Yes; because of |
| of cover or | the lowest | | forming pressure |
| rod core | forming | | limitation, the |
| structure | pressure, there is | | variability is less. |
| | structure | | |
| | variability in | | |
| | mold/finished | | |
| | product. | | |

From the comparison of the above table, it is demonstrated that this invention achieves the characteristics of Fe-Al-Si long rod core production, and component respective forming. Comparing to the former Type 1 and Type 2, there are advantages including multiple structure variation, and using in application of high current and high induction.

### BRIEF DESCRIPTION OF THE SEVERAL VIEWS OF THE DRAWINGS

FIG. 1 is the exploded three-dimensional figure of assembling magnetic component in this invention.

FIG. 2 is the three-dimensional figure of assembling magnetic component product in this invention.

FIG. 3 is the exploded three-dimensional figure of coil winding on insulating bobbin in this invention.

FIGS. 4 to 6 are the three-dimensional figures of top and bottom covers with different variations in this invention.

FIGS. 7 to 9 are the cross section views of top and bottom covers with different height variations in this invention.

FIGS. 10 to 14 are the three-dimensional figures of top and bottom covers with different through hole variations in this invention.

FIGS. 15 to 17 are the three-dimensional figures of rod core with different variations in this invention.

FIGS. 18 to 20 are the cross section views of rod core with different variations in this invention.

FIG. 21 is the three-dimensional figure of top and bottom covers with multiple coil combination in this invention.

FIGS. 22 to 25 are the three-dimensional figures of function demonstration of function hole in this invention.

FIG. 26 is the exploded three-dimensional figure of traditional magnetic component with integral rod core and cover.

FIG. 27 is the exploded three-dimensional figure of traditional magnetic component with separated rod core and cover.

### DETAILED DESCRIPTION OF THE INVENTION

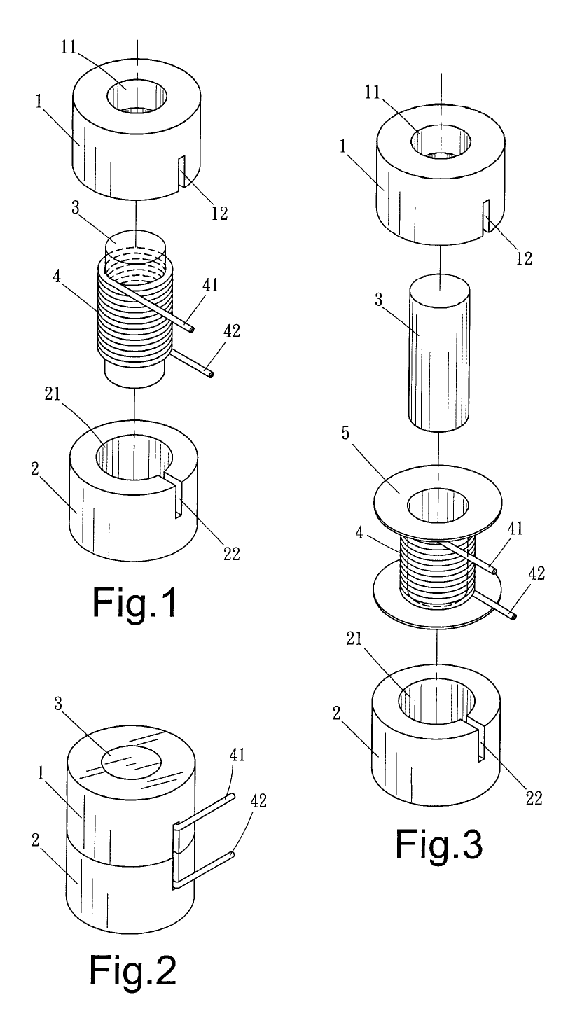

As demonstrated in FIGS. 1 and 2 of this invention, assembling magnetic component in this invention is mainly composed of top cover (1), bottom cover (2), rod core (3), and coil (4).

The basic shape of above-mentioned top cover (1) and bottom cover (2) is cup-like body. There is one through hole in the center (11), (21) and one rectangle hole on the side (12), (22).

The material of top cover (1) and bottom cover (2) is iron or Fe—Si insulating magnetic powder. It forms after cold-forming technology. The width range of rectangle hole (12), (22) is 0.5 mm˜10 mm, and the diameter of top cover (1) and bottom cover (2) is recommended to be 20 mm˜120 mm. The wall thickness of top cover (1) and bottom cover (2) is recommended to be more than 1 mm. As for the above-mentioned size, the actual size will be in accordance with customer's electric property requirement. The main function of top cover (1) and bottom cover (2) is to be the medium of magnetic field path and provide the whole component environment protection.

The basic shape of above-mentioned rod core (3) is solid cylinder, and the material is the insulating iron powder made by Fe—Al—Si powder. It forms after cold-forming technology. In this invention, 0.1%˜10% copper powder is added into insulating magnetic powder. Copper powder is softer, so it effectively reduces friction of green part release and strengthens green tape strength. The cylinder's outer diameter is less than the inner diameter of through hole (11), (21) in the top cover (1), and bottom cover (2). The main function of rod core (3) is to provide inductive magnetic field, and the height (length) of rod core (3) product could be more than 52 mm.

The above-mentioned coil (4) mainly coils on rod core (3). Electrical connectors (41), (42) extend at two ends. After the assembling of top cover (1) and bottom cover (2), electrical connectors (41), (42) extend outward through rectangle hole (12), (22) in the cover's wall. The main function of coil is for the current flow from one of the electrical connectors (41) or (42), which produces external magnetic field.

The assembling is to set rod core (3) into coil (4), and then put two ends into the through hole (11), (21) of top cover (1) and bottom cover (2) separately. After top cover (1) and bottom cover (2) combine and electrical connectors (41), (42) extending from two ends of the coil (4) extend outward through rectangle hole (12), (22), glue is used to bind to top cover (1) and bottom cover (2) and assemble the assembling magnetic component of this invention.

When rod core (3) is too long or coiling winding is considered, method demonstrated in FIG. 3 can be used when putting into practice. Coil is winded at insulating bobbin (5), which is assembled with rod core (3), top cover (1) and bottom cover (2) afterward.

### Component and the Derivative Variation of Design

### A. Variation of Top and Bottom Covers:

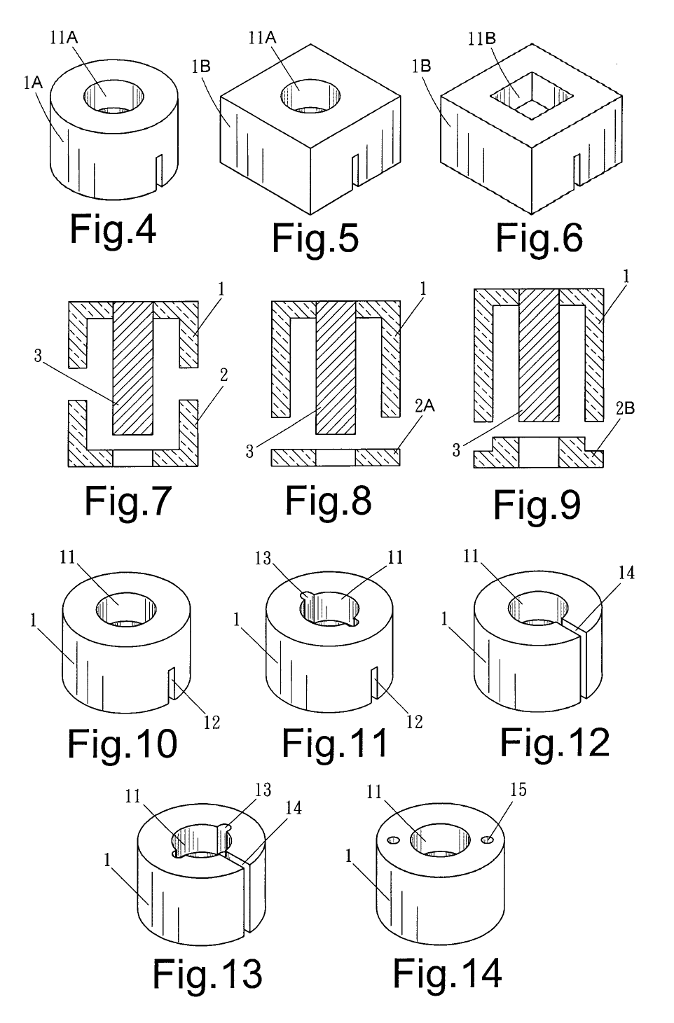

Please see FIGS. 4 to 6 as the reference. Top cover (1), bottom cover (2), through hole (11), (21) and rectangle hole (12), (22) of this invention include the following shape variations:
As demonstrated in FIG. 4, top cover and bottom cover are cylinder covers (1A), in which rod core through hole is circle (11A), and the assembled rod core is also cylinder;
As demonstrated in FIG. 5, top cover and bottom cover are square covers (1B), in which rod core through hole is circle (11A), and the assembled rod core is also cylinder;
As demonstrated in FIG. 6, top cover and bottom cover are square covers (1B), in which rod core through hole is square (11B), and the assembled rod core is also square column.

Please see FIGS. 7 to 9 as the reference. The following are the main variations in the height of top cover (1) and bottom cover (2) in this invention:
As demonstrate in FIG. 7, top cover (1) and bottom cover (2) are cup-like bodies in the same height.
As demonstrated in FIG. 8, top cover (1) is still cup-like body, but bottom cover (2) is flat plate body (2A);
As demonstrated in FIG. 9, top cover (1) is still cup-like body, but bottom cover (2) is trapezoidal body (2B) with thick middle and thin outer edge.

Please see FIGS. 10 to 14 as the reference. The following are the main variations of through hole (11), (21) and rectangle hole (12), (22) in top cover (1) and bottom cover (2) of this invention:
As demonstrated in FIG. 10, there are two holes in the cover. One is in the center in the cup-like cover. It's used for rod core assembling. Another is the rectangle hole in the cover's wall. It's retained as the exit of coil (4) electrical connector (41).
As demonstrated in FIG. 11, in addition to the through hole (11), (21) of rod core (3) at top cover (1) and bottom cover (2), there are single or several function holes (13) on the inner edge. The function of function hole (13) will be illustrated in the follow-up application chapter;
As demonstrated in FIG. 12, in addition to the through hole (11), (21) of rod core (3) at top cover (1) and bottom cover (2), there is a connected L-shape opening (14) at the end and the side. This approach will be helpful to use larger copper wire and expose surface area for effective cooling;
As demonstrated in FIG. 13, in addition to the through hole (11), (21) of rod core (3) at top cover (1) and bottom cover (2), there are function hole (13) and L-shape opening (14) simultaneously. However, too many holes will cause the emission of magnetic line and the reduction of AL, inductance rating.
As demonstrated in FIG. 14, in addition to the through hole (11), (21) of rod core (3) at top cover (1) and bottom cover (2), coil through hole (15) of electrical connector (41), (42) is set next to through hole (11), (21).

As for the function hole (13) and L-shape opening (14) of top cover (1) and bottom cover (2), the total hole length is asked to be less than ⅓ diameter of through hole (11), (21) by this patent design. Therefore, induction decline can be controlled within 10%.

### B. Rod Core Variation

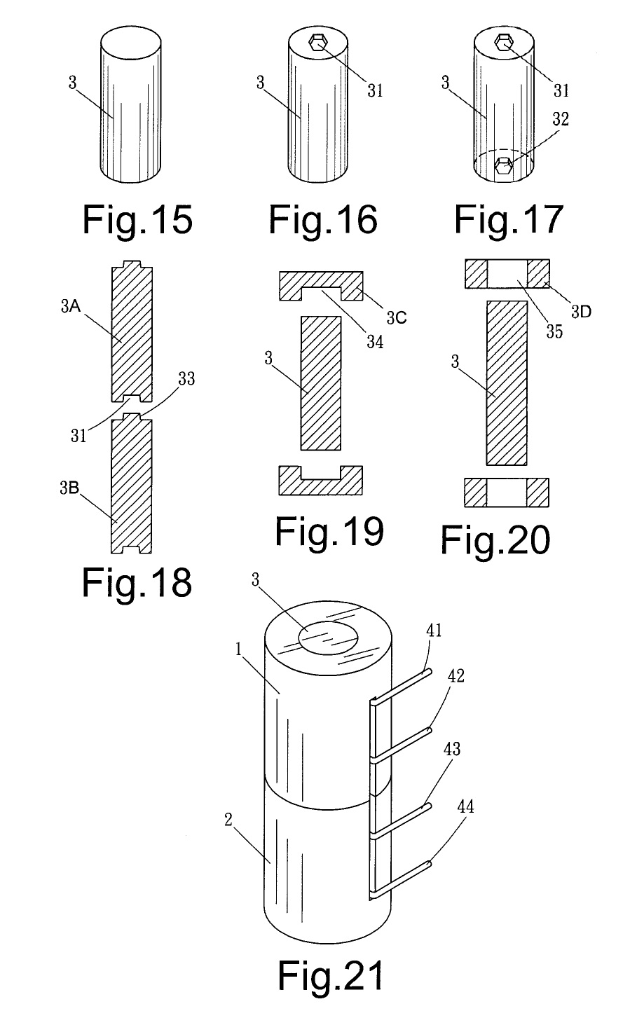

Please see FIGS. 15 to 20 as the reference. Rod core (3) of this invention includes the following structure variations:
As demonstrated in FIG. 15, the rod core (3) is solid cylinder rod core;
As demonstrated in FIG. 16, a counterbore (31) is set at one end of rod core (3). The shape of counterbore includes circle, triangle, rectangle and hexagon, which are easy to make. This counterbore can be used for the axis driving force of coil winding;
As demonstrated in FIG. 17, counterbores (31), (32) are set at two ends of rod core (3). The shape of counterbore includes circle, triangle, rectangle and hexagon, which are easy to make. This counterbore can be used for the axis driving force of coil winding;
As demonstrated in FIG. 18, a counterbore (31) or a lug (33) is set at one end of rod core (3), or counterbore (31) and lug (33) are set at two ends of rod core (3) respectively. This approach is able to produce long rod core or use different magnetic material effectively;
As demonstrated in FIG. 19, the rod core (3) is three-piece assembling. The middle is solid rod shape rod core (3), and the upper and bottom sides are groove rod cores (3C) with groove (34). After assembling, I shape is formed, which is beneficial for coil winding;
As demonstrated in FIG. 20, the rod core (3) is another kind of three-piece assembling. The middle is solid rod shape rod core (3), and the upper and bottom sides are ring-like rod cores (3D) with hole (35). After assembling, I shape is formed, which is beneficial for coil winding.

As demonstrated in FIG. 21, one or more rod cores (3), (3B) are connected and put into more than two coils (4A), (4B), and then top cover (1) and bottom cover (2) are combined, which produces magnetic component of multiple electrical connectors (41), (42), (43) &(44).

### Application Explanation of Function Hole:

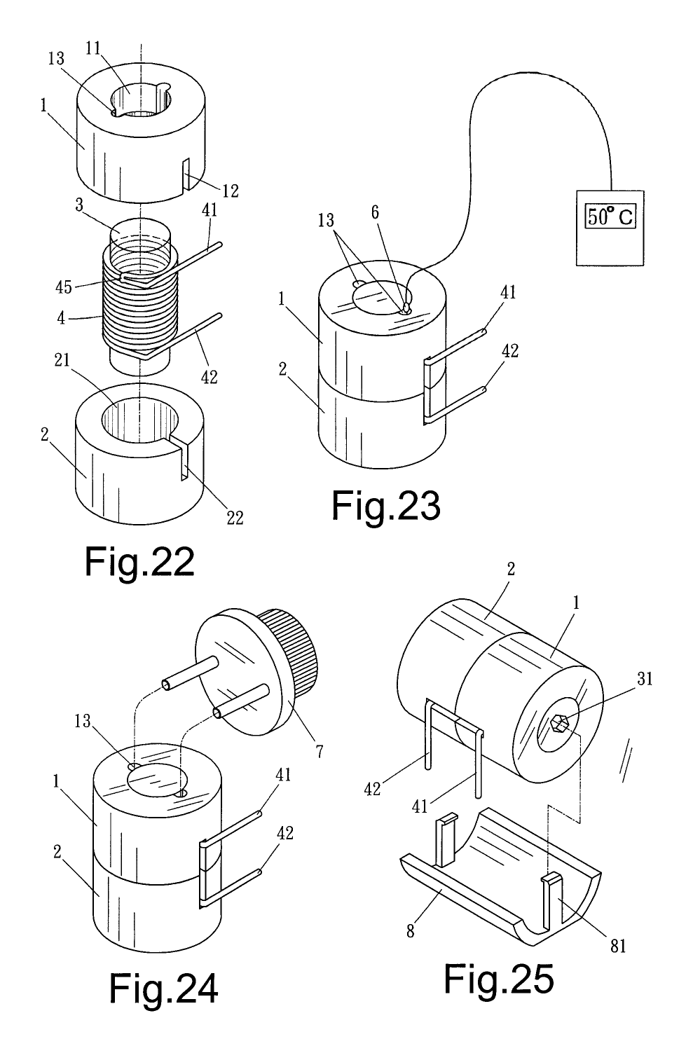

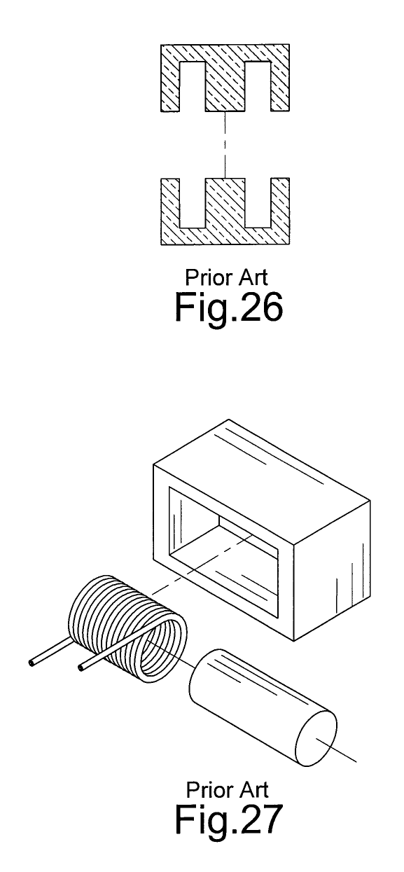

The following are the functions of the above-mentioned function hole (13):
A. Line escaping function: As demonstrated in FIG. 22, coil (4) is produced by insulating cooper wire winding. After that, the electrical connector (41), (42) of extended magnetic component must bend from the inner part of coil (4), in order to connect to circuit board electricity. This bend part will cause a bending convex circle section (45), and function hole (13) will provide the space for this bending convex circle section.
B. Temperature detection wire binding function: As demonstrated in FIG. 23, there is usually higher heat problem in the coil inner part of general magnetic component. This function hole (13) can be used to set temperature detector (6), which detects the heat condition of magnetic component.
C. Heat sink binding function: As demonstrated in FIG. 24, this function hole (13) can be used to bind heat sink (7), and it can bring out the heat generated in the coils.
D. Base binding tenon function: As demonstrated in FIG. 25, in specific condition, insulating base is asked (8) to be set between circuit boards, and then magnetic component can be fixed on circuit board. Function hole (13) can be used as the fixing hole of tenon (81) binding.

1. An assembling magnetic component, which includes:
A pair of symmetric top cover (1) and bottom cover (2), and the shape is cup-like body, there is a through hole (11), (21) in the middle, and a rectangle hole (12), (22)at the side, top cover (1) and bottom cover (2) are produced by insulating magnetic powder of iron or Fe—Si, and they form after cold forming, the width range of rectangle hole (12), (22) is 0.5 mm˜10 mm, and the diameter of top cover (1) and bottom cover (2) is recommended to be 20 mm˜120 mm;
the wall thickness of top cover (1) and bottom cover (2) is recommended to be more than 1 mm. The main function of top cover (1) and bottom cover (2) is to be the medium of magnetic field path and provide the whole component environment protection;
rod core (3) is solid cylinder, and the material is insulating magnetic powder made by Fe—Al—Si powder, it forms after cold-forming technology, 0.1%˜10% copper powder is added into insulating iron powder, because of the hardness characteristic of copper powder, it effectively reduces friction of green part release and strengthens green part strength, the cylinder outer diameter is less than the inner diameter of through hole (11), (21) in the top cover(1),and bottom cover (2);
the main function of rod core (3) is to provide inductive magnetic field, and the height (length) of rod core (3) product could be more than 52 mm;
coil (4) mainly is winded on rod core(3), electrical connectors (41), (42) extend at two ends, the main function of coil (4) is for the current flow from one of the electrical connectors (41) or (42), which produces external magnetic field;
the assembling is to set rod core (3) into coil (4), and then put two ends into the through hole (11), (21) of top cover (1) and bottom cover (2) separately, after top cover (1) and bottom cover (2) combine and electrical connectors (41), (42) extending from two ends of the coil (4) extend outward through rectangle hole (12), (22), glue is used to bind cover (1) and bottom cover (2) and assemble the assembling magnetic component of this invention.

2. The assembling magnetic component according to claim 1, the coil (4) can be winded at insulating bobbin (5) which is assembled with rod core (3), top cover (1) and bottom cover (2) afterward.

3. The assembling magnetic component according to claim 1, the top cover (1), bottom cover (2), through hole (11), (21) and rectangle hole (12), (22) include the following shape variations:
top cover and bottom cover are cylinder covers (1A), in which rod core through hole is circle (11A), and the assembled rod core is also cylinder;
top cover and bottom cover are square covers (18), in which rod core through hole is circle (11A), and the assembled rod core is also cylinder;
top cover and bottom cover are square covers (1B), in which rod core through hole is square (11B), and the assembled rod core is also square column;
top cover (1) and bottom cover (2) are cup-like bodies in the same height;
top cover (1) is still cup-like body, but bottom cover (2) is flat plate body (2A);
top cover (1) is still cup-like body, but bottom cover (2) is trapezoidal body (2B) with thick middle and thin outer edge;
in addition to the through hole (11), (21) at top cover (1) and bottom cover (2) which accommodates rod core (3), and an rectangle hole (12), (22) is retained at the side as the exit of coil (4) electrical connector (41), (42);
in addition to the through hole (11), (21) of rod core (3) at top cover (1) and bottom cover (2), there are single or several function holes (13) on the inner edge;
in addition to the through hole (11), (21) of rod core (3) at top cover (1) and bottom cover (2), there is a connected L-shape opening (14) at the end and the side, this approach will be helpful to use larger copper wire and expose surface area for effective cooling;
in addition to the through hole (11), (21) of rod core (3) at top cover (1) and bottom cover (2), there are function hole (13) and L-shape opening (14) simultaneously, however, too many holes will cause the emission of magnetic line and the reduction of AL, inductance rating;
In addition to the through hole (11), (21) of rod core (3) at top cover (1) and bottom cover (2), coil through hole (15) of electrical connector (41), (42) is set next to through hole (11), (21).

4. The assembling magnetic component according to claim 1, concerning the function hole (13) and L-shape opening (14) of top cover (1) and bottom cover (2), the total hole length can't be more than ⅓ diameter of through hole (11), (21), therefore, induction decline can be controlled within 10%.

5. The assembling magnetic component according to claim 1, the rod core (3) includes the following structure variations:
the rod core (3) is solid cylinder rod core;
a counterbore (31) is set at one end of rod core (3), the shape of counterbore includes circle, triangle, rectangle and hexagon, which are easy to make, this counterbore can be used for the axis driving force of of coil winding;
as demonstrated in FIG. 17, counterbores (31), (32) are set at two ends of rod core (3), the shape of counterbore includes circle, triangle, rectangle and hexagon, which are easy to use, this counterbore can be used for the axis driving force of coil winding;
a counterbore (31) or a lug (33) is set at one end of rod core (3), or counterbore (31) and lug (33) are set at two ends of rod core (3) respectively, so two or more rod cores (3A), (3B) are connected. This approach is able to produce long rod core or use different magnetic material effectively;
the rod core (3) is three-piece assembling. The middle is solid rod shape rod core (3), and the upper and bottom sides are groove rod cores (3C) with groove (34), after assembling, I shape is formed, which is beneficial for coil winding;
the rod core (3) is another kind of three-piece assembling, the middle is solid rod shape rod core (3), and the upper and bottom sides are coil winding cores (3D) with hole (35), after assembling, I shape is formed, which is beneficial for coiling.

6. The assembling magnetic component according to claim 5, one or more rod cores (3), (3B) are connected and put into more than two coils (4A), (4B), and then top cover (1) and bottom cover (2) are combined, which produces magnetic component of multiple electrical connectors (41), (42), (43), (44).

7. The assembling magnetic component according to claim 3, the function hole (13) on top cover (1), bottom cover (2) provide the space for bending convex circle section (45).

8. The assembling magnetic component according to claim 3, temperature detector (6) can be set in function hole (13) on top cover (1), bottom cover (2), which detects the heat condition of magnetic component.

9. The assembling magnetic component according to claim 3, the heat sink (7) can be bonded in function hole (13) on top cover (1), bottom cover (2), and it can bring out the heat generated in the coils.

10. The assembling magnetic component according to claim 3, the function hole (13) on top cover (1), bottom cover (2) can be used as the fixing way for magnetic component, when insulating base (8) is asked to be set between circuit boards, binding tenon (81) of insulating base (8) stabilizes the function hole (13).
